(19) United States
(12) Patent Application Publication
(10) Pub. No.: US 2022/0368179 A1
(43) Pub. Date: Nov. 17, 2022

(54) MOTOR

(71) Applicant: EXEDY Corporation, Osaka (JP)

(72) Inventors: Koki OHNO, Osaka (JP); Kohsuke MURATA, Osaka (JP); Yoshifumi SHIMOGAKI, Osaka (JP)

(21) Appl. No.: 17/717,447

(22) Filed: Apr. 11, 2022

(30) Foreign Application Priority Data
May 11, 2021 (JP) 2021-080367

(51) Int. Cl. H02K 1/18; H02K 3/50; H02K 11/33

(52) U.S. Cl. CPC H02K 1/187; H02K 3/50; H02K 11/33; H02K 2203/06; H02K 2211/03

(57) ABSTRACT

A motor includes a housing, a stator, and a printed wiring board. The housing includes a bottom part. The stator is supported by the housing. The printed wiring board is supported by the housing in a state of being disposed apart from the bottom part.

### CROSS-REFERENCE TO RELATED APPLICATIONS

This application claims priority to Japanese Patent Application No. 2021-080367 filed May 11, 2021. The entire contents of that application are incorporated by reference herein in their entirety.

### TECHNICAL FIELD

The present invention relates to a motor.

### BACKGROUND ART

A motor includes a rotor, a stator, and a printed wiring board. As described in Japan Laid-open Patent Application Publication No. 2011-166857, the printed wiring board is supported by engaging pawls axially extending from an insulator of the stator.

In the motor configured as described above, the engaging pawls axially extend from the insulator to support the printed wiring board. Hence, the motor is increased in axial dimension by that much. This has been posed as a drawback.

It is an object of the present invention to support a printed wiring board in a motor without increase in axial dimension of the motor.

### BRIEF SUMMARY

A motor according to an aspect of the present invention includes a housing, a stator, and a printed wiring board. The housing includes a bottom part. The stator is supported by the housing. The printed wiring board is supported by the housing in a state of being disposed apart from the bottom part.

According to this configuration, the printed wiring board is supported by the housing; hence, it is not required to extend any engaging pawl from an insulator. As a result, the printed wiring board can be supported in the motor without increase in axial dimension of the motor.

Preferably, the housing includes an outer peripheral wall part and a plurality of pedestals. The plurality of pedestals extend radially inward from the outer peripheral wall part. The printed wiring board is put on the plurality of pedestals.

Preferably, the printed wiring board includes a first through hole. The housing includes a support pin that extends from each of the plurality of pedestals and is inserted into the first through hole.

Preferably, the plurality of pedestals each include a second through hole. The support pin is press-fitted to the second through hole.

Preferably, the printed wiring board is a double-sided printed wiring board.

Preferably, the housing includes an inner peripheral wall part. The stator is supported by the inner peripheral wall part.

Preferably, the printed wiring board includes a first face, a second face, and a third through hole. The first face is opposed to the stator. The second face is opposed to the bottom part. The third through hole penetrates the printed wiring board from the first face to the second face. The stator includes a coil and a conductor wire extending from the coil. The conductor wire is soldered to the second face, and the conductor wire penetrates the printed wiring board through the third through hole.

Overall, according to the present invention, the printed wiring board can be supported in the motor without increase in axial dimension of the motor.

### BRIEF DESCRIPTION OF THE DRAWINGS

FIG. 1 is a plan view of a motor.

FIG. 2 is a cross-sectional view of FIG. 1 taken along line A-A.

FIG. 3 is a plan view of a base part of a housing.

FIG. 4 is a plan view of the base part to which a printed wiring board is attached.

### DETAILED DESCRIPTION

A motor according to the present preferred embodiment will be hereinafter explained with reference to drawings. It should be noted that in the following explanation, the term “axial direction” refers to an extending direction of a rotational axis of a rotor. On the other hand, the term “circumferential direction” refers to a circumferential direction of an imaginary circle about the rotational axis, whereas the term “radial direction” refers to a radial direction of the imaginary circle about the rotational axis.

### [Motor]

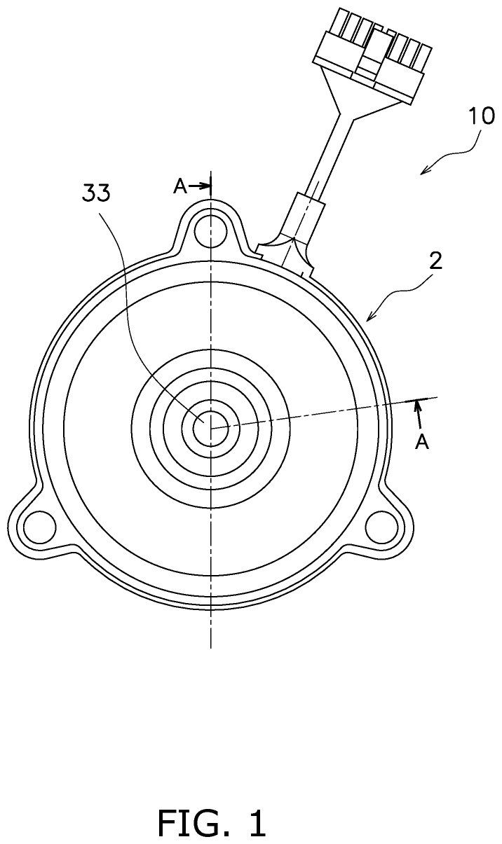

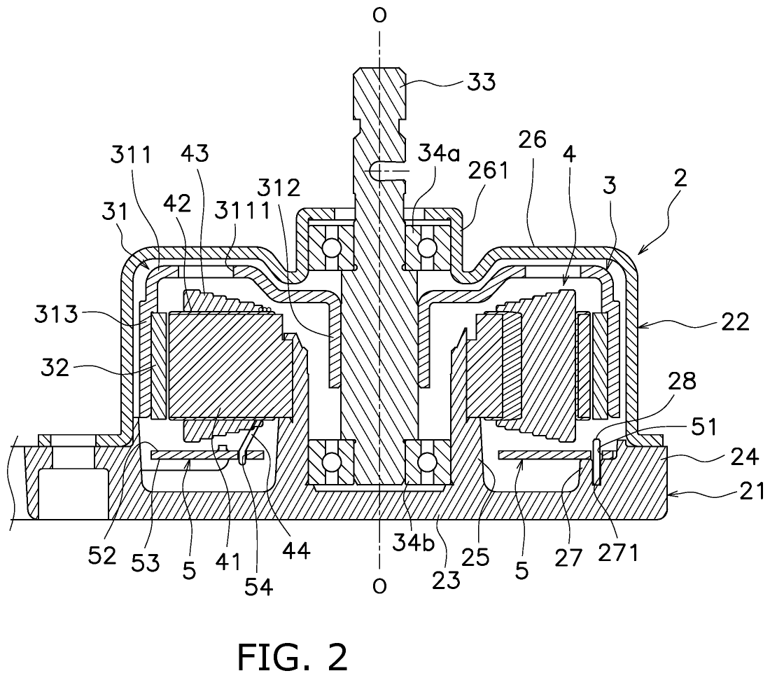

FIG. 1 is a plan view of a motor 10, whereas FIG. 2 is a cross-sectional view of FIG. 1 taken along line A-A. As shown in FIGS. 1 and 2, the motor 10 includes a housing 2, a rotor 3, a stator 4, and a printed wiring board 5. The motor 10 is of an outer rotor type. The motor 10 is attachable to a carrier such as a hand pallet jack or truck, a cart, or an automated guided vehicle.

### [Housing]

The housing 2 is configured to accommodate the rotor 3, the stator 4, and the printed wiring board 5. The housing 2 is composed of a base part 21 and a cover part 22. The cover part 22 is fixed to the base part 21.

The housing 2 includes a bottom part 23, an outer peripheral wall part 24, an inner peripheral wall part 25, and a top plate part 26. The bottom part 23 has a disc shape. The outer peripheral wall part 24 has a cylindrical shape. The outer peripheral wall part 24 extends from the outer peripheral edge of the bottom part 23 to the top plate part 26. The outer peripheral wall part 24 is divided into a portion of the base part 21 and a portion of the cover part 22.

The inner peripheral wall part 25 has a cylindrical shape. The inner peripheral wall part 25 is disposed radially inside the outer peripheral wall part 24. The inner peripheral wall part 25 extends from the bottom part 23 toward the top plate part 26. It should be noted that the inner peripheral wall part 25 does not extend enough to reach the top plate part 26. In other words, the distal end of the inner peripheral wall part 25 is disposed apart from the top plate part 26 at an interval.

The top plate part 26 has a disc shape. The outer peripheral wall part 24 extends from the outer peripheral edge of the top plate part 26 to the bottom part 23. The top plate part 26 includes a protruding portion 261 having a cylindrical shape. The protruding portion 261 is disposed in the middle of the top plate part 26. The protruding portion 261 axially extends to the opposite side of the bottom part 23.

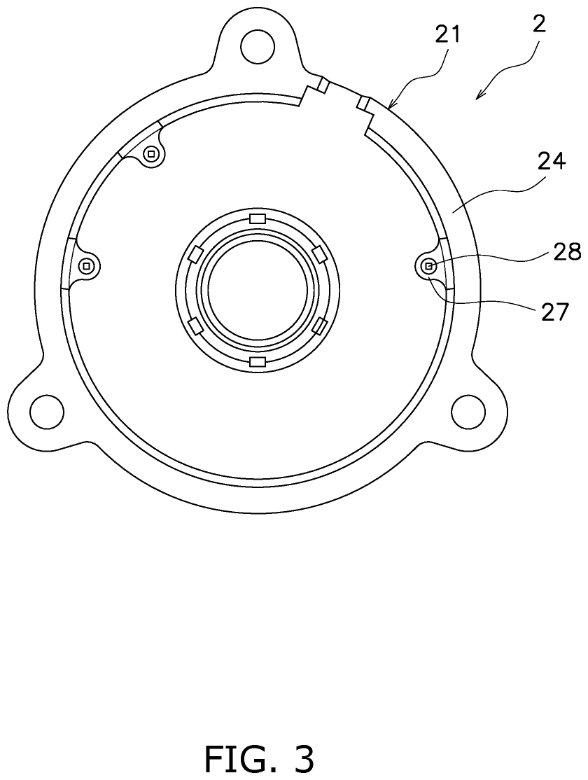

FIG. 3 is a plan view of the base part 21 of the housing 2. As shown in FIGS. 2 and 3, the housing 2 includes a plurality of pedestals 27 and a plurality of support pins 28. It should be noted that in the present preferred embodiment, the housing 2 includes three pedestals 27 and three support pins 28.

The pedestals 27 extend radially inward from the outer peripheral wall part 24. Besides, the pedestals 27 axially extend from the bottom part 23. The pedestals 27 are integrated with the outer peripheral wall part 24 and the bottom part 23 to form a single member.

The pedestals 27 are circumferentially disposed apart from each other at intervals. The pedestals 27 may be disposed at equal intervals, albeit not herein disposed at equal intervals.

Each pedestal 27 includes a second through hole 271. The second through hole 271 extends in the axial direction. Each support pin 28 axially extends from each pedestal 27. When described in detail, each support pin 28 is press-fitted to the second through hole 271. The distal end of each support pin 28 protrudes from the second through hole 271.

### [Rotor]

As shown in FIG. 2, the rotor 3 is supported by the housing 2 in rotatable manner. The rotor 3 includes a rotor frame 31, a magnet 32, and a shaft 33.

The rotor frame 31 includes a disc portion 311, an inner peripheral guide portion 312, and an outer peripheral guide portion 313. The disc portion 311 includes an opening in the middle thereof. The disc portion 311 is disposed axially between the stator 4 and the top plate part 26. The disc portion 311 includes a plurality of through holes 3111. The through holes 3111 are aligned in the circumferential direction.

The inner peripheral guide portion 312 has a cylindrical shape. The inner peripheral guide portion 312 axially extends from the inner peripheral end of the disc portion 311. The inner peripheral guide portion 312 extends from the disc portion 311 toward the bottom part 23.

The outer peripheral guide portion 313 has a cylindrical shape. The outer peripheral guide portion 313 axially extends from the outer peripheral end of the disc portion 311 toward the bottom part 23.

The magnet 32 is a permanent magnet. The magnet 32 is attached to the outer peripheral guide portion 313 of the rotor frame 31. When described in detail, the magnet 32 is attached to the inner peripheral surface of the outer peripheral guide portion 313. The magnet 32 is disposed radially outside the stator 4. In other words, the magnet 32 is disposed to enclose the stator 4.

The shaft 33 is supported by the housing 2 in rotatable manner. When described in detail, the shaft 33 is supported by the housing 2 through two bearings 34a and 34b. On the one hand, the shaft 33 is supported by the bearing 34a attached to the interior of the protruding portion 261 of the housing 2. On the other hand, the shaft 33 is supported by the bearing 34b attached to the interior of the inner peripheral wall part 25 of the housing 2.

The shaft 33 axially extends to the outside of the housing 2, while penetrating the middle of the top plate part 26. The shaft 33 supports the rotor frame 31. The shaft 33 is unitarily rotated with the rotor frame 31. The shaft 33 is press-fitted to the inner peripheral guide portion 312 of the rotor frame 31.

### [Stator]

The stator 4 is supported by the housing 2. When described in detail, the stator 4 is supported by the inner peripheral wall part 25. The stator 4 is disposed inside the housing 2 in non-rotatable manner. The stator 4 includes a stator core 41, an insulator 42, a plurality of coils 43, and a conductor wire 44.

The stator core 41 can be formed by laminating a plurality of electromagnetic steel plates. The insulator 42 is configured to cover the stator core 41. When described in detail, the insulator 42 covers teeth of the stator core 41. The insulator 42 is made of a material with insulating properties (e.g., resin).

The coils 43 are wound about the stator core 41. When described in detail, the coils 43 are wound about the teeth of the stator core 41. It should be noted that the insulator 42 described above is interposed between the coils 43 and the teeth. Besides, the insulator 42 is interposed as well between the coils 43 and a yoke of the stator core 41.

The conductor wire 44 extends from the coils 43 toward the bottom part 23. It should be noted that the conductor wire 44 is part of conductor wires for forming the coils 43.

### [Printed Wiring Board]

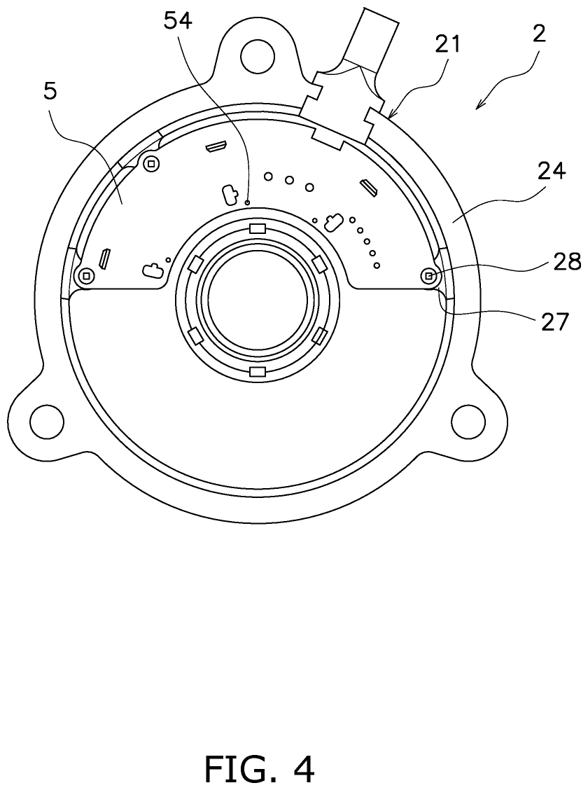

FIG. 4 is a plan view of the base part 21 of the housing 2 to which the printed wiring board 5 is attached. As shown in FIGS. 2 and 4, the printed wiring board 5 is supported by the housing 2. When described in detail, the printed wiring board 5 is put on the pedestals 27. Thus, the printed wiring board 5 is in contact with the housing 2.

The printed wiring board 5 is disposed apart from the bottom part 23 at an interval. The printed wiring board 5 is disposed between the stator 4 and the bottom part 23.

The printed wiring board 5 has a C-shape and is disposed between the outer peripheral wall part 24 and the inner peripheral wall part 25. The printed wiring board 5 is disposed apart from both the outer peripheral wall part 24 and the inner peripheral wall part 25 at intervals. The printed wiring board 5 includes a plurality of first through holes 51 in the outer peripheral edge thereof. The first through holes 51 are equal in number to the support pins 28. The support pins 28 are inserted into the first through holes 51, respectively, whereby the printed wiring board 5 is circumferentially set in place.

The printed wiring board 5 is a double-sided printed wiring board. The printed wiring board 5 includes a first face 52, a second face 53, and a third through hole 54. The first face 52 is opposed to the stator 4. The second face 53 is opposed to the bottom part 23. The third through hole 54 penetrates the printed wiring board 5 from the first face 52 to the second face 53.

The conductor wire 44 is soldered to the second face 53, while penetrating the printed wiring board 5 through the third through hole 54. It should be noted that the conductor wire 44 extends from the coils 43 to the second face 53 in slack manner. Besides, the support pins 28 are soldered to the first face 52 of the printed wiring board 5.

### [Modifications]

One preferred embodiment of the present invention has been explained above. However, the present invention is not limited to the above, and a variety of changes can be made without departing from the gist of the present invention.

### Modification 1

In the preferred embodiment described above, each support pin 28 is press-fitted to the second through hole 271 of each pedestal 27. However, the configuration of each support pin 28 is not limited to this. For example, each support pin 28 may be integrated with each pedestal 27 to form a single member.

### Modification 2

In the preferred embodiment described above, the support pins 28 are soldered to the printed wiring board 5. However, the method of fixing the printed wiring board 5 by the support pins 28 is not limited to this. For example, the printed wiring board 5 may be fixed by bending the distal ends of the support pins 28 penetrating the first through holes 51 of the printed wiring board 5. Other than this configuration, the printed wiring board 5 may be fixed by swaging using swaging pins provided as the support pins 28.

### Modification 3

In the preferred embodiment described above, the printed wiring board 5 has a C-shape. However, the shape of the printed wiring board 5 is not limited to this. For example, the printed wiring board 5 may be made in shape of an annulus.

### REFERENCE SIGNS LIST

2: Housing
23: Bottom part
24: Outer peripheral wall part
25: Inner peripheral wall part
27: Pedestal
271: Second through hole
28: Support pin
4: Stator
43: Coil
44: Conductor wire
5: Printed wiring board
51: First through hole
52: First face
53: Second face
54: Third through hole
10: Motor

What is claimed is:

1. A motor comprising:
a housing including a bottom part;
a stator supported by the housing; and
a printed wiring board supported by the housing in a state of being disposed apart from the bottom part.

2. The motor according to claim 1, wherein
the housing includes an outer peripheral wall part and a plurality of pedestals extending radially inward from the outer peripheral wall part, and
the printed wiring board is put on the plurality of pedestals.

3. The motor according to claim 2, wherein
the printed wiring board includes a first through hole, and
the housing includes a support pin extending from each of the plurality of pedestals, the support pin inserted into the first through hole.

4. The motor according to claim 3, wherein
the plurality of pedestals each include a second through hole, and
the support pin is press-fitted to the second through hole.

5. The motor according to claim 1, wherein the printed wiring board is a double-sided printed wiring board.

6. The motor according to claim 1, wherein
the housing includes an inner peripheral wall part, and
the stator is supported by the inner peripheral wall part.

7. The motor according to claim 1, wherein
the printed wiring board includes a first face, a second face, and a third through hole, the first face opposed to the stator, the second face opposed to the bottom part, the third through hole penetrating the printed wiring board from the first face to the second face,
the stator includes a coil and a conductor wire extending from the coil, and
the conductor wire is soldered to the second face, the conductor wire penetrating the printed wiring board through the third through hole.
